(19) United States
(12) Patent Application Publication
(10) Pub. No.: US 2025/0246912 A1
(43) Pub. Date: Jul. 31, 2025

(54) ENERGY STORAGE MULTIPLEX REGULATION METHOD, SYSTEM THEREOF AND ELECTRONIC DEVICE

(71) Applicant: NORTH CHINA ELECTRIC POWER UNIVERSITY, BEIJING (CN)

(72) Inventors: XIAOHE YAN, BEIJING (CN); NIAN LIU, BEIJING (CN); BINHUAN GAO, BEIJING (CN)

(21) Appl. No.: 18/973,348

(22) Filed: Dec. 9, 2024

(30) Foreign Application Priority Data
Jan. 25, 2024 (CN) 202410100845.1

(51) Int. Cl. H02J 3/32; H02J 7/00

(52) U.S. Cl. CPC H02J 3/32; H02J 7/0048; H02J 7/00712; H02J 2203/20

(57) ABSTRACT

Provided is an energy storage multiplex operation method, a system thereof and an electronic device, which relates to a field of energy storage operation. The method includes: acquiring coefficients of electricity services in which an energy storage system participates; solving an energy storage operation model of the energy storage system in a current multiplexing mode according to the coefficients of different electricity services to obtain a charging power or a discharging power of the energy storage system under different electricity services; and performing, by the energy storage system, charging or discharging operation on different electricity services, according to the charging power or discharging power of the energy storage system under different electricity services. According to different multiplexing modes and in combination with efficiency maximization, the proportion and the charging and discharging capacity of the energy storage system under various electricity services are calculated and determined.

### CROSS-REFERENCE TO RELATED APPLICATION

This disclosure claims the benefit and priority of Chinese Patent Application No. 202410100845.1 filed with the China National Intellectual Property Administration on Jan. 25, 2024, the disclosure of which is incorporated by reference herein in its entirety as part of the disclosure.

### TECHNICAL FIELD

The present disclosure relates to the field of energy storage operation, in particular to an energy storage multiplex operation method, a system thereof and an electronic device.

### BACKGROUND

In recent years, with the increasing attention to the sustainability of an energy system and the stability of a power network, traditional energy production and consumption patterns are facing many challenges, including unstable energy supply, energy waste, carbon emissions and other issues. Therefore, researchers begin to explore how to effectively integrate renewable energy (such as solar energy and wind energy) into the energy system and solve the problems due to fluctuation of the renewable energy. As a key means to solve energy fluctuation, the energy storage technology has attracted wide attention. By introducing energy storage facilities into the energy system, excess energy can be stored when the energy supply is excessive, and energy can be released at the peak of demand, so as to realize the balanced allocation of energy. However, the energy storage operation involves not only the storage and release of energy, but also takes into account factors such as the interaction with a power system, the operation of an energy market, the technical feasibility and the economic benefits. In this context, researchers begin to pay attention to an optimization method of energy storage operation, an intelligent management system, the performance improvement of an energy storage device, and the potential of energy storage to participate in multiplexing services. It is of great significance to study the energy storage multiplexing mode, which is mainly reflected in the following aspects: maximum utilization of resources, flexibility of the energy system, reduction of costs and risks, support of energy transformation, and innovation and development. Research on the energy storage multiplexing mode plays an important role in realizing efficient, flexible and sustainable operation of the energy system. This method can maximize the coefficient of the energy storage system and promote the sustainable development of the energy industry.

The existing models mainly focus on the participation of the energy storage in a single electricity service. However, due to the difference of risks between multi-electricity services, the requirements for the energy storage capacity are also different (for example, the frequency regulation market requires rapid adjustment, while the spot energy service requires long-term charging and discharging). Therefore, when only participating in a single service, the energy storage may face the problems of low efficiency, high risk and inability to effectively use energy storage capacity for adjustment. Participating in the multiplexing service enables the energy storage to allocate its own capacity more flexibly and contribute to the large-scale construction of energy storage.

### SUMMARY

The present disclosure aims to provide an energy storage multiplex operation method, a system thereof and an electronic device, so as to improve the energy storage operating efficiency.

In order to achieve the above objectives, the present disclosure provides the following scheme.

An energy storage multiplex operation method is provided, which includes: acquiring coefficients of electricity services in which an energy storage system participates, where the electricity services include a spot energy service and an ancillary service, and wherein the energy storage system includes a plurality of battery packs and a battery management system;
inputting the coefficients to an energy storage operation model of the energy storage system in a current multiplexing mode for solving, to output a charging power or a discharging power of the energy storage system under different electricity services; where the multiplexing mode includes time division multiplexing, frequency division multiplexing or active and reactive power coupling multiplexing; the energy storage operation model is established with a maximum daily energy storage efficiency as an objective function and with an electricity service weight constraint, energy storage charging and discharging constraints and an SoC constraint as constraint conditions; and
controlling, by the battery management system, the battery packs to perform charging or discharging operation, according to the charging power or discharging power of the energy storage system under different electricity services, so as to allocate power to different electricity services.

In some embodiments, the objective function is expressed as maxl=maxΣₜ₌₁²⁴Σᵢ₌₁ⁿλ_{i,t}(P_{d,i,t}−P_{c,i,t})−C_{d},
where λ_{i,t} denotes a coefficient of an i-th electricity service in which the energy storage system participates at moment t, P_{d,i,t} denotes a discharging power of the energy storage system upon participating in the i-th electricity service at moment t, P_{c,i,t} denotes a charging power of the energy storage system upon participating in the i-th electricity service at moment t, and C_{d} denotes a use cost of the energy storage system.

In some embodiments, the energy storage charging and discharging constraints are expressed as: P_{c}_{ₘᵢₙ}≤P_{c,t}≤P_{c}_{ₘₐₓ}; P_{d}_{ₘᵢₙ}≤P_{d,t}≤P_{d}_{ₘₐₓ}; 0≤P_{c,t}≤P_{c}_{ₘₐₓ}×A_{E}; 0≤P_{d,t}≤P_{d}_{ₘₐₓ}×(1−A_{E});
where P_{c,t} is a total charging power of the energy storage system upon participating in the electricity service at moment t; P_{d,t} is a total discharging power of the energy storage system upon participating in the electricity service at moment t; P_{c}_{ₘᵢₙ} is a lower limit of a charging power of the energy storage system upon participating in the electricity service; Pcmax is an upper limit of the charging power of the energy storage system upon participating in the electricity service; P_{d}_{ₘᵢₙ} is a lower limit of a discharging power of the energy storage system upon participating in the electricity service; P_{d}_{ₘₐₓ} denotes an upper limit of the discharging power upon participating in the electricity service; and A_{E} is a binary variable with a value of 0 or 1.

In some embodiments, the SoC constraint is expressed as: SoCₘᵢₙ≤SoCₜ≤SoCₘₐₓ; SoC(24)=SoC(1);
where SoCₘᵢₙ is a minimum value of a state of charge; SoCₘₐₓ is a maximum value of the state of charge; SoCₜ is a state of charge at moment t; SoC(1) is a state of charge at a first moment; and SoC(24) is a state of charge at a last moment.

In some embodiments, the electricity service weight constraint in a time division multiplexing mode is expressed as:

$$\begin{matrix}{\sum }_{i = 1}^{n} {w}_{i . t} = 1 , {P}_{c , i , t} ⋃ {P}_{d , i , t} \neq 0 \\ {w}_{1 , t} = {w}_{2 , t} = … = {w}_{n , t} = 0 , {P}_{c , i , t} ⋂ {P}_{d , i , t} = 0\end{matrix} ; {W}_{i . t} ∈ \{ 0 , 1 \} ;$$

where w_{i,t} is a weight of an i-th electricity service in which the energy storage system participates at moment t; i=1, . . . , n, n is a total number of electricity services; P_{c,i,t} is a charging power of the energy storage system upon participating in the i-th electricity service at moment t; and P_{d,i,t} is a discharging power of the energy storage system upon participating in the i-th electricity service at moment t.

In some embodiments, the electricity service weight constraint in a frequency division multiplexing mode with fixed-proportion capacity allocation is expressed as:

$$\begin{matrix}{\sum }_{i = 1}^{n} {w}_{i . t} = 1 , {P}_{c , i , t} ⋃ {P}_{d , i , t} \neq 0 \\ {w}_{1 , t} = {w}_{2 , t} = … = {w}_{n , t} = 0 , {P}_{c , i , t} ⋂ {P}_{d , i , t} = 0\end{matrix} ; 0 \leq {W}_{i , t} \leq 1 ; {w}_{i . t} = Const ;$$

where w_{i,t} is a weight of an i-th electricity service in which the energy storage system participates at moment t; i=1, . . . , n, n is a total number of electricity services; P_{c,i,t} is a charging power of the energy storage system upon participating in the i-th electricity service at moment t; P_{d,i,t} is a discharging power of the energy storage system upon participating in the i-th electricity service at moment t; and Const is a fixed constant.

In some embodiments, the electricity service weight constraint in the frequency division multiplexing mode with flexible proportion capacity allocation is expressed as:

$$\begin{matrix}{\sum }_{i = 1}^{n} {w}_{i . t} = 1 , {P}_{c , i , t} ⋃ {P}_{d , i , t} \neq 0 \\ {w}_{1 , t} = {w}_{2 , t} = … = {w}_{n , t} = 0 , {P}_{c , i , t} ⋂ {P}_{d , i , t} = 0\end{matrix} ; 0 \leq {W}_{i , t} \leq 1 ;$$

where w_{i,t} is a weight of an i-th electricity service in which the energy storage system participates at moment t; i=1, . . . , n, n is a total number of electricity services; P_{c,i,t} is a charging power of the energy storage system upon participating in the i-th electricity service at moment t; and P_{d,i,t} is a discharging power of the energy storage system upon participating in the i-th electricity service at moment t.

In some embodiments, the electricity service weight constraint in an active and reactive power coupling multiplexing mode is expressed as:

$$\begin{matrix}{\sum }_{i = 1}^{n} {w}_{i . t} = 1 , {P}_{c , i , t} ⋃ {P}_{d , i , t} \neq 0 \\ {w}_{1 , t} = {w}_{2 , t} = … = {w}_{n , t} = 0 , {P}_{c , i , t} ⋂ {P}_{d , i , t} = 0\end{matrix} ; 0 \leq {W}_{i , t} \leq 1 ;$$

where w_{i,t} is a weight of an i-th electricity service in which the energy storage system participates at moment t; i=1, . . . , n, n is a total number of electricity services; P_{c,i,t} is a charging power of the energy storage system upon participating in the i-th electricity service at moment t; and P_{d,i,t} is a discharging power of the energy storage system upon participating in the i-th electricity service at moment t.

An energy storage multiplex operation system is also provided, which includes a data acquisition module and a charging and discharging power determining module. The data acquisition module is configured to acquire coefficients of electricity services in which an energy storage system participates, where the electricity services include a spot energy service and an ancillary service, where the energy storage system comprises a plurality of battery packs and a battery management system.

The charging and discharging power determining module is configured to input the coefficients to energy storage operation model of the energy storage system in a current multiplexing mode for solving, to output a charging power or a discharging power of the energy storage system under different electricity services, where the multiplexing mode includes time division multiplexing, frequency division multiplexing or active and reactive power coupling multiplexing; the energy storage operation model is established with a maximum daily energy storage efficiency as an objective function and with an electricity service weight constraint, energy storage charging and discharging constraints and an SoC constraint as constraint conditions.

The battery management system controls the battery packs to perform charging or discharging operation according to the charging power or discharging power of the energy storage system under different electricity services, so as to allocate power to different electricity services.

An electronic device is further provided, which includes a memory and a processor, where the memory is configured to store a computer program, and the processor operates the computer program to cause the electronic device to implement the energy storage multiplex operation method described above.

According to the specific embodiment provided by the present disclosure, the present disclosure provides the following technical effects. The present disclosure provides an energy storage multiplex operation method, a system thereof and an electronic device. The method includes: acquiring coefficients of electricity service in which an energy storage system participates; solving an energy storage operation model of the energy storage system in a current multiplexing mode according to the coefficients of different electricity services to obtain a charging power or a discharging power of the energy storage system under different electricity services, where the multiplexing mode includes time division multiplexing, frequency division multiplexing or active and reactive power coupling multiplexing; the energy storage operation model is established with a maximum daily energy storage efficiency as an objective function and with an electricity service weight constraint, energy storage charging and discharging constraints and an SoC constraint as constraint conditions; and performing, by the energy storage system, charging or discharging operation on different electricity services, according to the charging power or discharging power of the energy storage system under different electricity services. According to different multiplexing modes and in combination with efficiency maximization, the proportion and the charging and discharging capacity of the energy storage system under various electricity services are calculated and determined, so that the energy storage can allocate its own capacity more flexibly, improve the energy storage operation efficiency and contribute to the large-scale construction of energy storage.

### BRIEF DESCRIPTION OF THE DRAWINGS

In order to explain the embodiments of the present disclosure or the technical schemes in the prior art more clearly, the drawings that need to be used in the embodiments will be briefly introduced. Obviously, the drawings in the following description are only some embodiments of the present disclosure. For those skilled in the art, other drawings can be obtained according to these drawings without creative labor.

FIG. 1 is a flow chart of an energy storage multiplex operation method according to the present disclosure.

FIG. 2 is a schematic diagram of an energy storage system participating in multiplexing electricity services.

FIG. 3 is a schematic diagram of time division multiplexing.

FIG. 4 is a schematic diagram of fixed-proportion frequency division multiplexing.

FIG. 5 is a schematic diagram of flexible-proportion frequency division multiplexing.

FIG. 6 is a flow chart of an energy storage multiplex operation method according to the present disclosure in practical application.

### DETAILED DESCRIPTION OF THE EMBODIMENTS

The technical schemes in the embodiments of the present disclosure will be clearly and completely described with reference to the drawings in the embodiments of the present disclosure hereinafter. Obviously, the described embodiments are only some embodiments of the present disclosure, rather than all of the embodiments. Based on the embodiment of the present disclosure, all other embodiments obtained by those skilled in the art without creative labor fall within the scope of protection of the present disclosure.

The purpose of the present disclosure is to provide an energy storage multiplex operation method, a system thereof and an electronic device, so as to improve the energy storage operation efficiency.

In order to make the above objects, features and advantages of the present disclosure more obvious and understandable, the present disclosure will be explained in further detail with reference to the drawings and detailed description hereinafter.

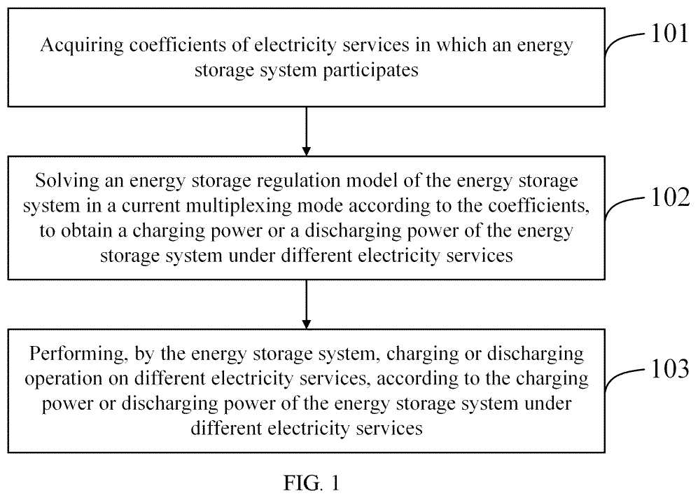

Embodiment 1: As shown in FIG. 1, the energy storage multiplex operation method provided by the present disclosure includes Step 101 to Step 103.

In Step 101, coefficients of electricity services in which an energy storage system participates are acquired, where the electricity services include a spot energy service and an ancillary service, where the ancillary service may include: an ancillary service, a frequency regulation market and/or a voltage regulation service. The spot energy service involves energy storage system supplying power to the grid. Ancillary services are all services required by the transmission or distribution system operator to enable them to maintain the integrity and stability of the transmission or distribution system as well as the power quality.

In Step 102, an energy storage operation model of the energy storage system in a current multiplexing mode is solved according to the coefficient, to obtain a charging power or a discharging power of the energy storage system under different electricity services, where the multiplexing mode includes time division multiplexing, frequency division multiplexing or active and reactive power coupling multiplexing; the energy storage operation model is established with a maximum daily energy storage efficiency as an objective function and with an electricity service weight constraint, energy storage charging and discharging constraints and an SoC constraint as constraint conditions.

In Step 103, charging or discharging operation is performed by the energy storage system on different electricity services according to the charging power or discharging power of the energy storage system under different electricity services.

The coefficient of electricity services refers to ratios at which total power is allocated by the energy storage system to different electricity services participated, i.e., a ratio of a power allocated to a certain electricity service to the total power. For example, an energy storage system with a rated total power of 100 MW participates in spot energy service at 50% of the rated total power and ancillary service at 50% of the rated total power at a certain time, that is, in the spot energy service, charging or discharging is performed at a power of 50 MW, and in the ancillary service, charging or discharging is performed at a power of 50 MW, and the coefficients of both are all 0.5.

The energy storage system includes multiple battery packs and a battery management system (BMS). The energy storage system allocates its own power to different electricity services for charging and discharging according to needs of different electricity services. Specifically, the energy storage system uses its own BMS to allocate power to the difference battery packs, and the battery packs is charged from and discharged to different electricity services. In some embodiments, the energy storage system can discharge during a peak period of power consumption with high electricity prices, while charge during a trough period of electricity consumption with low electricity prices, thereby obtaining a profit.

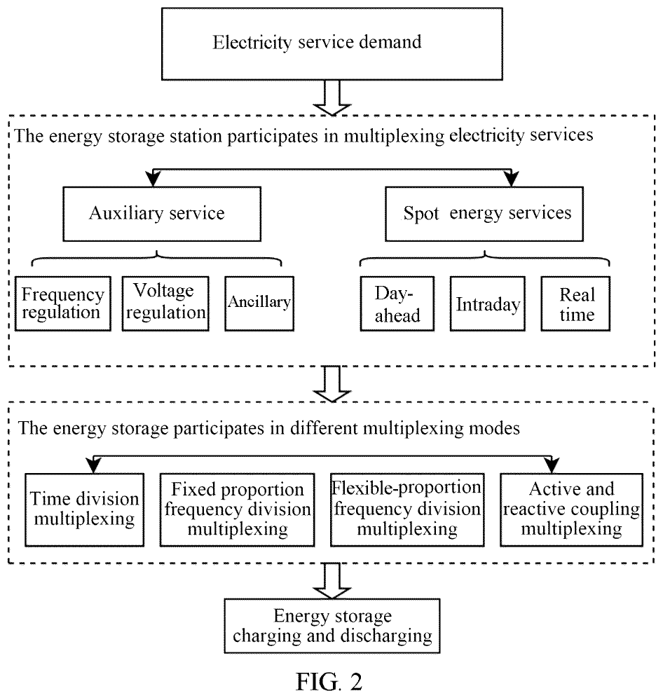

In practical application, as shown in FIG. 2, the present disclosure first divides the multiplexing modes for the energy storage system participating in multiplexing electricity services into time division multiplexing and frequency division multiplexing based on whether the energy storage system can participate in a plurality of electricity services at the same time. Thereafter, in consideration of the SoC constraint, the charging and discharging constraints, and the proportion constraint of different services, and aiming at maximizing the total efficiency of energy storage within 24 hours a day, a general operation model for the energy storage system participating in the multiplexing electricity services is established. Under a specific rated amount of energy storage, the maximum energy storage efficiency can be obtained by changing the coupling operation structure of the multiplexing power system. For different multiplexing modes, only by changing the parameters the energy storage operation model is constructed to obtain the optimal solution of charging and discharging. With the maximization of the energy storage income as the objective function for the general operation model, respective energy storage operation models are constructed in four multiplexing modes. The four multiplexing modes include time division multiplexing, fixed-proportion frequency division multiplexing, flexible-proportion frequency division multiplexing, and active and reactive power coupling multiplexing. According to different multiplexing modes, by changing the proportion of different services and in combination with efficiency maximization, the proportion and the charging and discharging capacity of the energy storage station under various services are calculated.

With the continuous improvement of the types and rules of electricity services, the energy storage system can participate in multiplexing of electricity services, and acquire coefficients from various electricity services. According to the maturity of electricity service rules, different multiplexing modes are classified. The energy storage system can compare the efficiency under various modes and select a multiplexing mode to participate in operation according to the actual situation.

### 1. Time Division Multiplexing

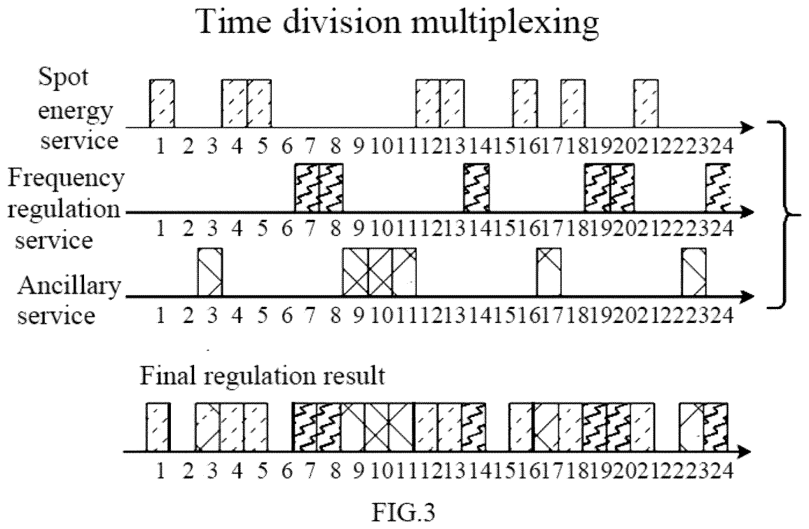

Time division multiplexing is a communication technology, which is used to realize communication between multiple users in limited resources. As shown in FIG. 3, resource conflict and interference are avoided by allocating resources to different users or signals in different time periods. Time division multiplexing is the easiest way to implement from the technical point of view. The energy storage system only participates in one electricity service at the same time, but the energy storage system can participate in different electricity services according to its actual operating characteristics at different time periods of the day. For example, the coefficient is the highest in the peak period of power consumption, and the energy storage system is discharged by participating in the spot energy service at this time. The coefficient is the lowest in the trough period of power consumption, and the energy storage system is charged by participating in the spot energy service at this time. The energy storage system is put into auxiliary service in the residual time. Alternatively, the energy storage system automatically selects the participated electricity service according to the electricity service incentive index of each time period to acquire the higher efficiency. Although the time division multiplexing mode is relatively simple and straightforward, it is a suitable choice at the initial stage of the formation of an electricity service incentive mechanism in China, which is undoubtedly an operation mode that can greatly improve the energy storage efficiency and adapt to the early development of the electricity service mechanism.

### 2. Frequency Division Multiplexing

Frequency division multiplexing is the continuation of time division multiplexing. After the electricity service incentive mechanism is mature, the energy storage system can freely choose to participate in different services according to its own needs, and is not limited to participating in a single service in the same time period, and can freely allocate capacity among different services in the same time period. For example, when participating in spot energy service, the energy storage system may be fully charged or empty for a long time due to the small fluctuation of excitation signals. In order to effectively utilize the energy storage resources, the energy storage system can participate in the frequency regulation market to acquire higher income. When the electricity service mechanism is mature, the mode can adapt to the profit demand and risk preference of energy storage operators, help the energy storage system to allocate its own capacity more flexibly, improve the efficiency level of energy storage, and reduce the time for the energy storage system to recover the investment cost. The energy storage system participating in frequency division multiplexing of multiplexing service needs to allocate its capacity reasonably, and such allocation mainly includes: fixed-proportion capacity allocation and flexible-proportion capacity allocation.

### (1) Fixed-Proportion Capacity Allocation

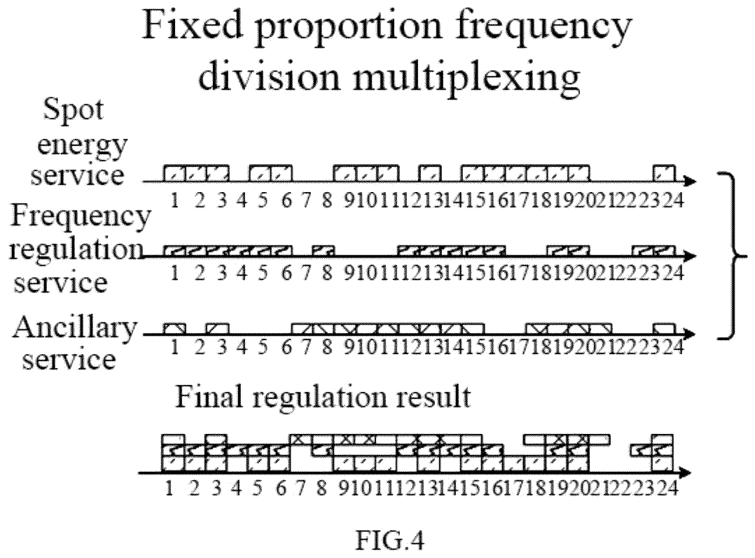

As shown in FIG. 4, using a fixed proportion to allocate energy storage capacity means to allocate the participating capacity of the energy storage to different services in advance at a fixed proportion, which depends on the requirements of superiors and historical data in actual operation. When the system operator has no operation requirements for the energy storage system, the capacity of the energy storage system is allocated in the participation mode with the highest efficiency according to historical data. When the system operator needs to operate the energy storage system, a certain proportion of the capacity of the energy storage system is allocated according to the requirements, and then the residual capacity continues to be allocated at different proportions for the energy storage system participating in different services in the participation mode with the highest efficiency according to historical data.

### (2) Flexible-Proportion Capacity Allocation

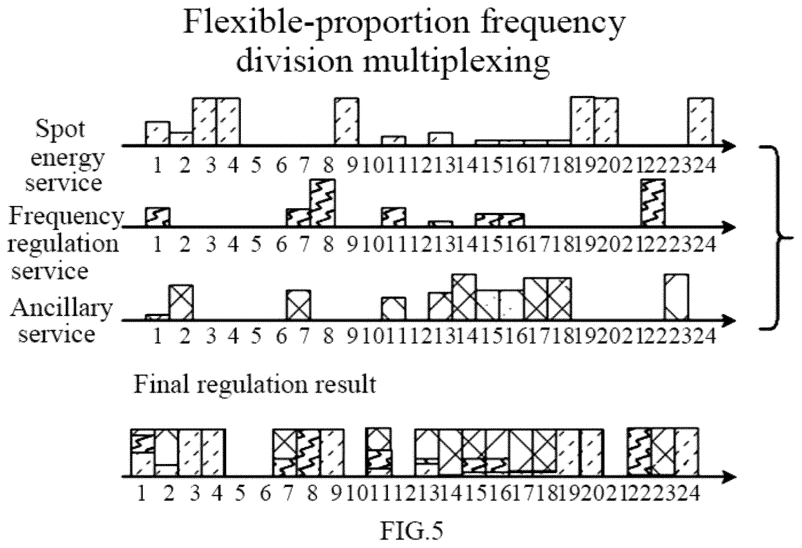

After the electricity service mechanism is mature enough, as shown in FIG. 5, the energy storage system can freely allocate the capacity for different market services at any moment to ensure the maximum efficiency. In actual operation, it is necessary to determine the proportion at different moments. The methods such as robust optimization, machine learning and particle swarm optimization are often used to determine the proportion data freely allocated to different services under the maximum efficiency objective, and further obtain the charging and discharging situation of the energy storage system participating in the operation within 24 hours of a day.

### 3. Active and Reactive Power Coupling Multiplexing

The above multiplexing modes are mainly aimed at multiplexing electricity services with active power as the main function and in which the energy storage system participates. However, there must be a certain degree of reactive power in the power system, which can be used to participate in voltage regulation services, etc. Therefore, after taking into account the active power coupling of the power system, with further improvement of the electricity service mechanism, reactive power can also be considered in energy storage multiplexing. Therefore, the multiplexing mode will introduce the active and reactive power multiplexing method of energy storage from the active and reactive power coupling inside an energy storage converter.

When the energy storage system participates in the coordinated operation of active and reactive powers, the active power mainly participates in the frequency regulation market in spot energy services and auxiliary services, and the reactive power mainly participates in the voltage regulation service in auxiliary services, and gains benefits therefrom. The capacity of participation in the active power and the reactive power is determined by the excitation size of each link. The active power and the reactive power can be freely allocated according to the coefficients of different services under the condition of satisfying capacity constraints. The energy constraints of the active power and the reactive power are as shown in formula (1) to formula (3).

$$0 \leq Δ {P}_{t} = {P}_{c , t} - {P}_{d , t} \leq Δ {P}_{max} \qquad ( 1 )$$

$$0 \leq Δ {Q}_{t} = \sqrt{{S}_{ini , i}^{2} - Δ {P}_{t}} - {Q}_{0 , t} \leq Δ {P}_{max} \qquad ( 2 )$$

$$\sqrt{Δ {P}_{t}^{2} + {( {Q}_{0 , t} + Δ {Q}_{t} )}^{2}} \leq {S}_{ini , i} \qquad ( 3 )$$

In formula (1), P_{c,t} and P_{d,t} denote a charging power and a discharging power of the energy storage system at moment t, respectively, ΔPₜ is an actual active power at moment t, and the formula (1) indicates that upper and lower limit constraints of the active power of the converter need to fall within the maximum limited power. In formula (2), S_{ini,t} denotes a total capacity of the energy storage station (energy storage system), Q_{0,t} is an initial reactive power of the energy storage station at moment t, ΔQₜ is an actual reactive power at moment t, and the formula (2) indicates that a reactive power adjustment of the converter needs to use the residual capacity of the converter after frequency regulation. The formula (3) indicates that the active power and the reactive power of the converter need to satisfy the capacity constraints of the converter. When energy storage participates in the coordinated operation of the active power and the reactive power, the reactive power part mainly uses the reactive power to participate in voltage regulation services, while the active power part can participate in a plurality of electricity services at the same time. In actual operation, an energy storage operation model needs to be established based on the multiplexing mode of energy storage selected in Step 1 aiming at maximizing the daily efficiency of energy storage within 24 hours.

The efficiency function of energy storage is expressed as formula (4) to formula (6).

$$max I = max {\sum }_{t = 1}^{24} {\sum }_{i = 1}^{n} {λ}_{i , t} ( {P}_{d , i , t} - {P}_{c , i , t} ) - {C}_{d} \qquad ( 4 )$$

$$\{ \begin{matrix}{\sum }_{i = 1}^{n} {w}_{i . t} = 1 , {P}_{c , i , t} ⋃ {P}_{d , i , t} \neq 0 \\ {w}_{1 , t} = {w}_{2 , t} = … = {w}_{n , t} = 0 , {P}_{c , i , t} ⋂ {P}_{d , i , t} = 0\end{matrix} \qquad ( 5 )$$

$$0 \leq {W}_{i , t} \leq 1 \qquad ( 6 )$$

where formula (4) denotes the maximum efficiency of the energy storage system within 24 hours of a day, λ_{i,t} denotes a coefficient of an i-th electricity service in which the energy storage system participates at moment t, P_{d,i,t} denotes a discharging power of the energy storage system upon participating in the i-th electricity service at moment t, P_{c,i,t} denotes a charging power of the energy storage system upon participating in the i-th electricity service at moment t, and C_{d} denotes a use cost of the energy storage system. In formula (5), w_{i,t} denotes a weight of each of electricity services. When the energy storage station performs charging or discharging operation, the sum of the weights allocated under different electricity services is equal to 1. When the energy storage station does not perform charging or discharging operation, the weights are all 0 because the energy storage station does not participate in electricity services at this time. Formula (6) indicates that the weight w_{i,t} is between 0 and 1. For energy storage participating in multiplexing electricity services, the model difference among multiplexing modes is mainly reflected in the different allocation proportions for different services, w_{i,t}. According to the different selected energy storage multiplexing modes, the corresponding electricity service weight constraints are as shown in formula (7) to formula (15).

In the time division multiplexing mode, the proportions for the energy storage system participating in different electricity services need to satisfy the following constraints.

$$\begin{matrix}{\sum }_{i = 1}^{n} {w}_{i . t} = 1 , {P}_{c , i , t} ⋃ {P}_{d , i , t} \neq 0 \\ {w}_{1 , t} = {w}_{2 , t} = … = {w}_{n , t} = 0 , {P}_{c , i , t} ⋂ {P}_{d , i , t} = 0\end{matrix} \qquad ( 7 )$$

$${W}_{i . t} ∈ \{ 0 , 1 \} \qquad ( 8 )$$

The formulas (7) and (8) show that when participating in electricity services in the time division multiplexing mode, the proportion of each electricity service is a variable from 0 to 1, thus limiting the participation in only one electricity service in the same time period. w_{i,t} is a weight of an i-th electricity service in which the energy storage system participates at moment t; and i=1, . . . , n, n is a total number of electricity services.

The electricity service weight constraint in the frequency division multiplexing mode with the fixed-proportion capacity allocation is as shown in formula (9) to formula (11).

$$\begin{matrix}{\sum }_{i = 1}^{n} {w}_{i . t} = 1 , {P}_{c , i , t} ⋃ {P}_{d , i , t} \neq 0 \\ {w}_{1 , t} = {w}_{2 , t} = … = {w}_{n , t} = 0 , {P}_{c , i , t} ⋂ {P}_{d , i , t} = 0\end{matrix} \qquad ( 9 )$$

$$0 \leq {W}_{i , t} \leq 1 \qquad ( 10 )$$

$${w}_{i . t} = Const \qquad ( 11 )$$

The formulas (9) to (11) show that the proportion for each electricity service is a constant, in a case of participating in the electricity services in the fixed-proportion multiplexing mode, and thus the proportions for participation in the electricity services are fixed, that is Const is a fixed constant.

The electricity service weight constraint in the frequency division multiplexing mode with the flexible-proportion capacity allocation is as shown in formula (12) to formula (13).

$$\begin{matrix}{\sum }_{i = 1}^{n} {w}_{i . t} = 1 , {P}_{c , i , t} ⋃ {P}_{d , i , t} \neq 0 \\ {w}_{1 , t} = {w}_{2 , t} = … = {w}_{n , t} = 0 , {P}_{c , i , t} ⋂ {P}_{d , i , t} = 0\end{matrix} \qquad ( 12 )$$

$$0 \leq {W}_{i , t} \leq 1 \qquad ( 13 )$$

The formulas (12) to (13) show that the proportion for each service can be adjusted between (0, 1), in a case of participating in the electricity service in the flexible-proportion multiplexing mode.

Because the reactive power is limited by the constraint of the active power, there is no need to add constraint conditions for reactive electricity services, but the proportions for participation in different active services need to satisfy the following constraints.

$$\begin{matrix}{\sum }_{i = 1}^{n} {w}_{i . t} = 1 , {P}_{c , i , t} ⋃ {P}_{d , i , t} \neq 0 \\ {w}_{1 , t} = {w}_{2 , t} = … = {w}_{n , t} = 0 , {P}_{c , i , t} ⋂ {P}_{d , i , t} = 0\end{matrix} \qquad ( 14 )$$

$$0 \leq {W}_{i , t} \leq 1 \qquad ( 15 )$$

The limitation of the formulas (14) to (15) is the same as that in the flexible-proportion multiplexing mode, which shows that the active power allocation in the active and reactive power coupling multiplexing mode follows the principle of flexible allocation.

In the case of controlling energy storage, in addition to the maximum efficiency as the objective function, it is also necessary to satisfy the constraint conditions such as the SoC constraint and the energy storage charging and discharging constraints.

(1) The SoC constraint is expressed as:

$${SoC}_{min} \leq {SoC}_{t} \leq {SoC}_{max} \qquad ( 16 )$$

$$SoC ( 24 ) = SoC ( 1 ) \qquad ( 17 )$$

where SoCₘᵢₙ is a minimum value of a state of charge; SoCₘₐₓ is a maximum value of a state of charge; SoCₜ is a state of charge at moment t; SoC(1) is a state of charge at a first moment; and SoC(24) is a state of charge at a last moment.

(2) Energy storage charging and discharging constraints are expressed as:

$${P}_{{c}_{min}} \leq {P}_{c , t} \leq {P}_{{c}_{max}} \qquad ( 18 )$$

$${P}_{{d}_{min}} \leq {P}_{d , t} \leq {P}_{{d}_{max}} \qquad ( 19 )$$

$$0 \leq {P}_{c , t} \leq {P}_{{c}_{max}} \times {A}_{E} \qquad ( 20 )$$

$$0 \leq {P}_{d , t} \leq {P}_{{d}_{max}} \times ( 1 - {A}_{E} ) \qquad ( 21 )$$

Formula (17) requires that the SoCs at the first moment and the last moment of the operation day be equal. Formula (18) and formula (19) represent the charging and discharging constraints of the energy storage system. In formula (20) and formula (21), the energy storage is constrained only in the state of charging or discharging at the same time. P_{c,t} is a total charging power of the energy storage system participating in electricity services at moment t; P_{d,t} is a total discharging power of the energy storage system participating in the electricity services at moment t; P_{c}_{ₘᵢₙ} is a lower limit of a charging power of the energy storage system participating in the electricity services; Pcmax is an upper limit of the charging power of the energy storage system participating in the electricity service; P_{d}_{ₘᵢₙ} is a lower limit of a discharging power of the energy storage system participating in the electricity service; P_{d}_{ₘₐₓ} denotes an upper limit of the discharging power of the energy storage system participating in the electricity services; and A_{E} is a binary variable with a value of 0 or 1.

The coefficient of the participated electricity service is acquired from the system, and then optimization and solution are performed based on the multiplexing mode selected in Step 2 and the corresponding operation model to obtain the powers of energy storage under different services, and charging and discharging operations are performed according to the results.

The types of electricity services include spot energy services mainly dealing with spot energy trading and auxiliary services mainly participating in frequency regulation and voltage regulation, and the proportions for these services need to be allocated. For energy storage with fixed capacity participating in the multiplexing market, the allocation proportions are different for different service types at different time. According to the proportion weight w_{i,t}, the relationship between the output among different services and the total output is determined, as shown in formula (22) to formula (25).

$${P}_{c , t} = {\sum }_{i = 1}^{n} {w}_{i , t} \times {P}_{c , i} \qquad ( 22 )$$

$${P}_{d , t} = {\sum }_{i = 1}^{n} {w}_{i , t} \times {P}_{d , i} \qquad ( 23 )$$

$${E}_{t} = ( 1 - α ) {E}_{t - 1} + {P}_{c , t} {η}_{c} - \frac{{P}_{d , t}}{{η}_{d}} \qquad ( 24 )$$

$${SoC}_{t} = \frac{{E}_{t}}{{CAP}_{E}} \qquad ( 25 )$$

where α denotes a self-loss rate of the battery, η_{c} and η_{d} denote the charging efficiency and the discharging efficiency of the energy storage system, respectively, Eₜ denotes the current power of the energy storage, SoCₜ denotes the real-time residual capacity of the battery, and CAP_{E} denotes the total capacity of the energy storage station.

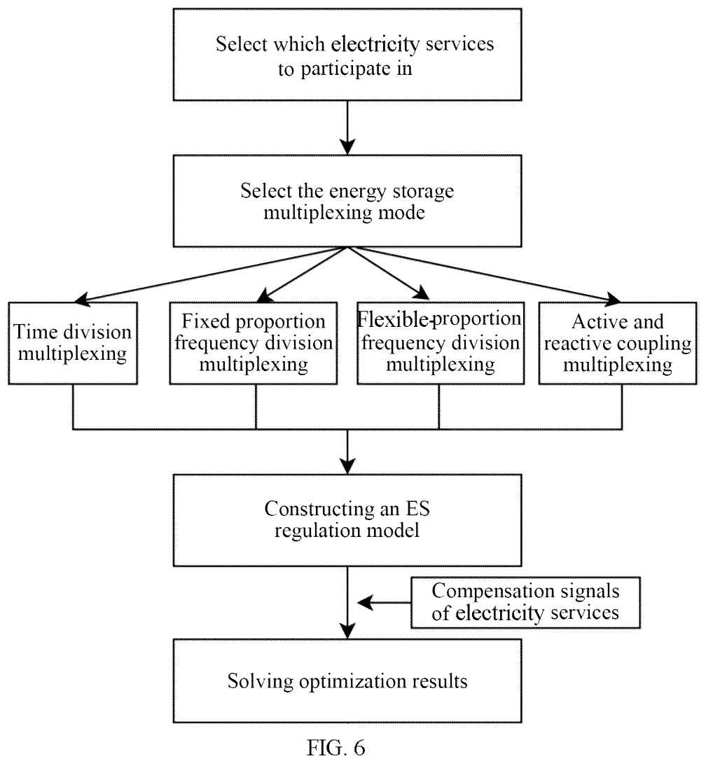

As shown in FIG. 6, first, according to the demand of different electricity services and the released excitation signals, the energy storage station can know which electricity services currently have a high demand or a high value, so as to determine which electricity services the energy of the energy storage station participates in.

Second, in the case of determining the service types of the participated multiplexing power system, in order to maximize the energy storage efficiency, a suitable way needs to be selected to determine the allocated proportion of energy storage. Therefore, the commercial value of energy storage can be further explored by using a plurality of energy storage multiplexing modes, and the architecture for operating the coupling of the multiplexing power system is constructed.

Finally, considering the maximal energy storage efficiency and different multiplexing modes, the operation model of the energy storage participating in multiplexing electricity services is established, the charging and discharging results of the energy storage station are solved, and the energy storage capacity is put into operation according to the charging and discharging results.

The multiplexing control method of the energy storage provided by the present disclosure has the following advantages. (1) The present disclosure provides a multiplexing architecture of the energy storage system participating in a plurality of different services, and based on this architecture, proposes a plurality of multiplexing modes of the energy storage system participating in a plurality of electricity services. According to the types of services in which energy storage participates at the same time, the energy storage multiplexing modes are divided into time division multiplexing, frequency division multiplexing, and active and reactive power coupling multiplexing. (2) The present disclosure takes into account the physical characteristics of the energy storage converter, and carries out the coordinated operation of the active power and the reactive power. In addition to the active power participating in spot energy services, the present disclosure allows the energy storage system to use the residual reactive power to participate in voltage regulation services, so as to obtain additional compensation, thus increasing the overall efficiency of energy storage. (3) The present disclosure provides a cost-efficiency operation model for the energy storage system participating in multiplexing of multiplexing electricity services. A mathematical model between the energy storage income and the charging and discharging capacity, and the use cost of the energy storage system and the selling price is established, and the optimization of operation of the energy storage station is realized with a maximum energy storage efficiency as the objective.

Embodiment 2: In order to implement the method corresponding to Embodiment 1 described above, so as to realize the corresponding functions and technical effects, an energy storage multiplex operation system is provided hereinafter, which includes a data acquisition module, a charging and discharging power determining module and a operation module.

The data acquisition module is configured to acquire coefficients of electricity services in which an energy storage system participates, wherein the electricity services include a spot energy service, an ancillary service, a frequency regulation market and/or a voltage regulation service.

The charging and discharging power determining module is configured to solve an energy storage operation model of the energy storage system in a current multiplexing mode according to the coefficients to obtain a charging power or a discharging power of the energy storage system under different electricity services, where the multiplexing mode includes time division multiplexing, frequency division multiplexing or active and reactive power coupling multiplexing; the energy storage operation model is established with a maximum daily energy storage efficiency as an objective function and with an electricity service weight constraint, energy storage charging and discharging constraints and an SoC constraint as constraint conditions.

The operation module is configured to perform charging or discharging operation on different electricity services by using the energy storage system, according to the charging power or discharging power of the energy storage system under different electricity services.

Embodiment 3: The present disclosure provides an electronic device, including a memory and a processor, where the memory is configured to store a computer program, and the processor operates the computer program to cause the electronic device to implement the energy storage multiplex operation method in Embodiment 1.

In this specification, various embodiments are described in a progressive way. The differences between each embodiment and other embodiments are highlighted, and the same and similar parts of various embodiments can be referred to each other. Since the system provided in the embodiment corresponds to the method provided in the embodiment, the system is described simply. Refer to the description of the method for the relevant points.

In the present disclosure, specific examples are applied to illustrate the principle and implementation of the present disclosure, and the explanations of the above embodiments are only used to help understand the method and core ideas of the present disclosure. At the same time, according to the idea of the present disclosure, there will be some changes in the specific implementation and application scope for those skilled in the art. To sum up, the contents of the specification should not be construed as limiting the present disclosure.

What is claimed is:

1. An energy storage multiplex operation method, comprising:
acquiring coefficients of electricity services in which an energy storage system participates, wherein the electricity services comprises a spot energy service and an ancillary service, and wherein the energy storage system comprises a plurality of battery packs and a battery management system;
inputting the coefficients to an energy storage operation model of the energy storage system in a current multiplexing mode for solving, to output a charging power or a discharging power of the energy storage system under different electricity services; wherein the multiplexing mode comprises time division multiplexing, frequency division multiplexing or active and reactive power coupling multiplexing; the energy storage operation model is established with a maximum daily energy storage efficiency as an objective function and with an electricity service weight constraint, energy storage charging and discharging constraints and an SoC constraint as constraint conditions; and
controlling, by the battery management system, the battery packs to perform charging or discharging operation, according to the charging power or discharging power of the energy storage system under different electricity services, so as to allocate power to different electricity services.

2. The energy storage multiplex operation method according to claim 1, wherein the objective function is expressed as: maxl=maxΣₜ₌₁²⁴Σᵢ₌₁ⁿλ_{i,t} (P_{d,i,t}−P_{c,i,t})−C_{d},
wherein λ_{i,t} denotes a coefficient of an i-th electricity service in which the energy storage system participates at moment t, P_{d,i,t} denotes a discharging power of the energy storage system upon participating in the i-th electricity service at moment t, P_{c,i,t} denotes a charging power of the energy storage system upon participating in the i-th electricity service at moment t, and C_{d} denotes a use cost of the energy storage system.

3. The energy storage multiplex operation method according to claim 1, wherein the energy storage charging and discharging constraints are expressed as:
$${P}_{{c}_{min}} \leq {P}_{c , t} \leq {P}_{{c}_{max}} ;$$
$${P}_{{d}_{min}} \leq {P}_{d , t} \leq {P}_{{d}_{max}} ;$$
$$0 \leq {P}_{c , t} \leq {P}_{{c}_{max}} \times {A}_{E} ;$$
$$0 \leq {P}_{d , t} \leq {P}_{{d}_{max}} \times ( 1 - {A}_{E} ) ;$$
wherein P_{c,t} is a total charging power of the energy storage system participating in the electricity services at moment t; P_{d,t} is a total discharging power of the energy storage system participating in the electricity services at moment t; P_{c}_{ₘᵢₙ} is a lower limit of a charging power of the energy storage system participating in the electricity service; Pcmax is an upper limit of the charging power of the energy storage system participating in the electricity service; P_{d}_{ₘᵢₙ} is a lower limit of a discharging power of the energy storage system participating in the electricity service; P_{d}_{ₘₐₓ} denotes an upper limit of the discharging power of the energy storage system participating in the electricity service; and A_{E} is a binary variable with a value of 0 or 1.

4. The energy storage multiplex operation method according to claim 1, wherein the SoC constraint is expressed as:
$${SoC}_{min} \leq {SoC}_{t} \leq {SoC}_{max} ;$$
$$SoC ( 24 ) = SoC ( 1 ) ;$$
wherein SoCₘᵢₙ is a minimum value of a state of charge; SoCₘₐₓ is a maximum value of the state of charge; SoCₜ is a state of charge at moment t; SoC(1) is a state of charge at a first moment; and SoC(24) is a state of charge at a last moment.

5. The energy storage multiplex operation method according to claim 1, wherein the electricity service weight constraint in a time division multiplexing mode is expressed as:
$${\sum }_{i = 1}^{n} {w}_{i \cdot t} = 1 , {P}_{c , i , t} ⋃ {P}_{d , i , t} \neq 0$$
$${w}_{1 , t} = {w}_{2 , t} = … = {w}_{n , t} = 0 , {P}_{c , i , t} ⋂ {P}_{d , i , t} = 0 ;$$
$${w}_{i \cdot t} ∈ \{ 0 , 1 \} ;$$
wherein w_{i,t} is a weight of an i-th electricity service in which the energy storage system participates at moment t; i=1, . . . , n, n is a total number of electricity services; P_{c,i,t} is a charging power of the energy storage system upon participating in the i-th electricity service at moment t; and P_{d,i,t} is a discharging power of the energy storage system upon participating in the i-th electricity service at moment t.

6. The energy storage multiplex operation method according to claim 1, wherein the electricity service weight constraint in a frequency division multiplexing mode with fixed-proportion capacity allocation is expressed as:
$${\sum }_{i = 1}^{n} {w}_{i \cdot t} = 1 , {P}_{c , i , t} ⋃ {P}_{d , i , t} \neq 0$$
$${w}_{1 , t} = {w}_{2 , t} = … = {w}_{n , t} = 0 , {P}_{c , i , t} ⋂ {P}_{d , i , t} = 0 ;$$
$$0 \leq {w}_{i , t} \leq 1 ;$$
$${w}_{i \cdot t} = Const ;$$
wherein w_{i,t} is a weight of an i-th electricity service in which the energy storage system participates at moment t; i=1, . . . , n, n is a total number of electricity services; P_{c,i,t} is a charging power of the energy storage system upon participating in the i-th electricity service at moment t; P_{d,i,t} is a discharging power of the energy storage system upon participating in the i-th electricity service at moment t; and Const is a fixed constant.

7. The energy storage multiplex operation method according to claim 1, wherein the electricity service weight constraint in the frequency division multiplexing mode with flexible proportion capacity allocation is expressed as:
$${\sum }_{i = 1}^{n} {w}_{i \cdot t} = 1 , {P}_{c , i , t} ⋃ {P}_{d , i , t} \neq 0$$
$${w}_{1 , t} = {w}_{2 , t} = … = {w}_{n , t} = 0 , {P}_{c , i , t} ⋂ {P}_{d , i , t} = 0 ;$$
$$0 \leq {w}_{i , t} \leq 1 ;$$
wherein w_{i,t} is a weight of an i-th electricity service in which the energy storage system participates at moment t; i=1, . . . , n, n is a total number of electricity services; P_{c,i,t} is a charging power of the energy storage system upon participating in the i-th electricity service at moment t; and P_{d,i,t} is a discharging power of the energy storage system upon participating in the i-th electricity service at moment t.

8. The energy storage multiplex operation method according to claim 1, wherein the electricity service weight constraint in an active and reactive power coupling multiplexing mode is expressed as:
$${\sum }_{i = 1}^{n} {w}_{i \cdot t} = 1 , {P}_{c , i , t} ⋃ {P}_{d , i , t} \neq 0$$
$${w}_{1 , t} = {w}_{2 , t} = … = {w}_{n , t} = 0 , {P}_{c , i , t} ⋂ {P}_{d , i , t} = 0 ;$$
$$0 \leq {w}_{i , t} \leq 1 ;$$
wherein w_{i,t} is a weight of an i-th electricity service in which the energy storage system participates at moment t; i=1, . . . , n, n is a total number of electricity services; P_{c,i,t} is a charging power of the storage system upon participating in the i-th electricity service at moment t; and P_{d,i,t} is a discharging power of the energy storage system upon participating in the i-th electricity service at moment t.

9. An energy storage multiplex operation system, comprising:
a data acquisition module configured to acquire coefficients of electricity services in which an energy storage system participates, wherein the electricity service comprises a spot energy service and an ancillary service, wherein the energy storage system comprises a plurality of battery packs and a battery management system; and
a charging and discharging power determining module configured to input the coefficients to an energy storage operation model of the energy storage system in a current multiplexing mode for solving, to output a charging power or a discharging power of the energy storage system under different electricity services, wherein the multiplexing mode comprises time division multiplexing, frequency division multiplexing or active and reactive power coupling multiplexing; the energy storage operation model is established with a maximum daily energy storage efficiency as an objective function and with an electricity service weight constraint, energy storage charging and discharging constraints and an SoC constraint as constraint conditions;
wherein the battery management system controls the battery packs to perform charging or discharging operation according to the charging power or discharging power of the energy storage system under different electricity services, so as to allocate power to different electricity services.

10. An electronic device, comprising a memory and a processor, wherein the memory is configured to store a computer program, and the processor operates the computer program to cause the electronic device to implement the energy storage multiplex operation method according to claim 1.

11. The electronic device according to claim 10, wherein the objective function is expressed as: maxl=maxΣₜ₌₁²⁴Σᵢ₌₁ⁿλ_{i,t}(P_{d,i,t}−P_{c,i,t})−C_{d},
wherein λ_{i,t} denotes a coefficient of an i-th electricity service in which the energy storage system participates at moment t, P_{d,i,t} denotes a discharging power of the energy storage system upon participating in the i-th electricity service at moment t, P_{c,i,t} denotes a charging power of the energy storage system upon participating in the i-th electricity service at moment t, and Ca denotes a use cost of the energy storage system.

12. The electronic device according to claim 10, wherein the energy storage charging and discharging constraints are expressed as:
$${P}_{{c}_{min}} \leq {P}_{c , t} \leq {P}_{{c}_{max}} ;$$
$${P}_{{d}_{min}} \leq {P}_{d , t} \leq {P}_{{d}_{max}} ;$$
$$0 \leq {P}_{c , t} \leq {P}_{{c}_{max}} \times {A}_{E} ;$$
$$0 \leq {P}_{d , t} \leq {P}_{{d}_{max}} \times ( 1 - {A}_{E} ) ;$$
wherein Pot is a total charging power of the energy storage system participating in the electricity services at moment t; P_{d,t} is a total discharging power of the energy storage system participating in the electricity services at moment t; P_{c}_{ₘᵢₙ} is a lower limit of a charging power of the energy storage system participating in the electricity service; Pcmax is an upper limit of the charging power of the energy storage system participating in the electricity service; P_{d}_{ₘᵢₙ} is a lower limit of a discharging power of the energy storage system participating in the electricity service; P_{d}_{ₘₐₓ} denotes an upper limit of the discharging power of the energy storage system participating in the electricity service; and A_{E} is a binary variable with a value of 0 or 1.

13. The electronic device according to claim 10, wherein the SoC constraint is expressed as:
$${SoC}_{min} \leq {SoC}_{t} \leq {SoC}_{max} ;$$
$$SoC ( 24 ) = SoC ( 1 ) ;$$
wherein SoCₘᵢₙ is a minimum value of a state of charge; SoCₘₐₓ is a maximum value of the state of charge; SoGₜ is a state of charge at moment t; SoC(1) is a state of charge at a first moment; and SoC(24) is a state of charge at a last moment.

14. The electronic device according to claim 10, wherein the electricity service weight constraint in a time division multiplexing mode is expressed as:
$${\sum }_{i = 1}^{n} {w}_{i \cdot t} = 1 , {P}_{c , i , t} ⋃ {P}_{d , i , t} \neq 0$$
$${w}_{1 , t} = {w}_{2 , t} = … = {w}_{n , t} = 0 , {P}_{c , i , t} ⋂ {P}_{d , i , t} = 0 ;$$
$${w}_{i \cdot t} ∈ \{ 0 , 1 \} ;$$
wherein w_{i,t} is a weight of an i-th electricity service in which the energy storage system participates at moment t; i=1, . . . , n, n is a total number of electricity services; P_{c,i,t} is a charging power of the energy storage system upon participating in the i-th electricity service at moment t; and P_{d,i,t} is a discharging power of the energy storage system upon participating in the i-th electricity service at moment t.

15. The electronic device according to claim 10, wherein the electricity service weight constraint in a frequency division multiplexing mode with fixed-proportion capacity allocation is expressed as:
$${\sum }_{i = 1}^{n} {w}_{i \cdot t} = 1 , {P}_{c , i , t} ⋃ {P}_{d , i , t} \neq 0$$
$${w}_{1 , t} = {w}_{2 , t} = … = {w}_{n , t} = 0 , {P}_{c , i , t} ⋂ {P}_{d , i , t} = 0 ;$$
$$0 \leq {w}_{i , t} \leq 1 ;$$
$${w}_{i \cdot t} = Const ;$$
wherein w_{i,t} is a weight of an i-th electricity service in which the energy storage system participates at moment t; i=1, . . . , n, n is a total number of electricity services; P_{c,i,t} is a charging power of the energy storage system upon participating in the i-th electricity service at moment t; P_{d,i,t} is a discharging power of the energy storage system upon participating in the i-th electricity service at moment t; and Const is a fixed constant.

16. The electronic device according to claim 10, wherein the electricity service weight constraint in the frequency division multiplexing mode with flexible proportion capacity allocation is expressed as:
$${\sum }_{i = 1}^{n} {w}_{i \cdot t} = 1 , {P}_{c , i , t} ⋃ {P}_{d , i , t} \neq 0$$
$${w}_{1 , t} = {w}_{2 , t} = … = {w}_{n , t} = 0 , {P}_{c , i , t} ⋂ {P}_{d , i , t} = 0 ;$$
$$0 \leq {w}_{i , t} \leq 1 ;$$
wherein with is a weight of an i-th electricity service in which the energy storage system participates at moment t; i=1, . . . , n, n is a total number of electricity services; P_{c,i,t} is a charging power of the energy storage system upon participating in the i-th electricity service at moment t; and P_{d,i,t} is a discharging power of the energy storage system upon participating in the i-th electricity service at moment t.

17. The electronic device according to claim 10, wherein the electricity service weight constraint in an active and reactive power coupling multiplexing mode is expressed as:
$${\sum }_{i = 1}^{n} {w}_{i \cdot t} = 1 , {P}_{c , i , t} ⋃ {P}_{d , i , t} \neq 0$$
$${w}_{1 , t} = {w}_{2 , t} = … = {w}_{n , t} = 0 , {P}_{c , i , t} ⋂ {P}_{d , i , t} = 0 ;$$
$$0 \leq {w}_{i , t} \leq 1 ;$$
wherein w_{i,t} is a weight of an i-th electricity service in which the energy storage system participates at moment t; i=1, . . . , n, n is a total number of electricity services; P_{c,i,t} is a charging power of the storage system upon participating in the i-th electricity service at moment t; and P_{d,i,t} is a discharging power of the energy storage system upon participating in the i-th electricity service at moment t.
